(19) United States
(12) Patent Application Publication
(10) Pub. No.: US 2025/0046026 A1
(43) Pub. Date: Feb. 6, 2025

(54) OPTICAL PRISM FOR AUGMENTED REALITY WAVEGUIDE WRAPPING ANGLE

(71) Applicant: Applied Materials, Inc., Santa Clara, CA (US)

(72) Inventors: David Alexander SELL, Santa Clara, CA (US); Sihui HE, Santa Clara, CA (US); Kevin MESSER, Mountain View, CA (US); Kunal SHASTRI, Santa Clara, CA (US); Jinxin FU, Fremont, CA (US); Samarth BHARGAVA, Saratoga, CA (US)

(21) Appl. No.: 18/793,389

(22) Filed: Aug. 2, 2024

Related U.S. Application Data
(60) Provisional application No. 63/517,814, filed on Aug. 4, 2023.

(51) Int. Cl. G06T 19/00; G02B 5/04; G02B 6/10

(52) U.S. Cl. CPC G06T 19/006; G02B 5/04; G02B 6/10

(57) ABSTRACT

The present disclosure relates to augmented reality devices and related methods. The augmented reality devices include a projection system. The projection system includes a projector including a major axis. The projected is configured to project an image along the major axis. A prism is configured to refract the image. The image includes a first spectrum, a second spectrum, and a third spectrum. A waveguide is disposed at a wrap angle from a plane formed from the major axis of the projector. The waveguide includes an input coupler, and an output coupler.

### CROSS-REFERENCE TO RELATED APPLICATIONS

This application claims priority to U.S. Provisional Patent Application Ser. No. 63/517,814 filed on Aug. 4, 2023, which is herein incorporated by reference in its entirety.

### BACKGROUND

### Field

Embodiments of the present disclosure generally relate to waveguides and augmented reality devices having projections systems and waveguides.

### Description of the Related Art

Virtual reality is generally considered to be a computer generated simulated environment in which a user has an apparent physical presence. A virtual reality experience can be generated in 3D and viewed with a head-mounted display (HMD), such as glasses or other wearable display devices that have near-eye display panels as lenses to display a virtual reality environment that replaces an actual environment. Augmented reality, however, enables an experience in which a user can still see through the display lenses of the glasses or other HMD device to view the surrounding environment, yet also see images of virtual objects that are generated for display and appear as part of the environment. Augmented reality can include any type of input, such as audio and haptic inputs, as well as virtual images, graphics, and video that enhances or augments the environment that the user experiences. As an emerging technology, there are many challenges and design constraints with augmented reality.

Accordingly, what is needed in the art are augmented reality devices with projections systems and waveguides.

### SUMMARY

In an embodiment, the present disclosure generally provides augmented reality devices. The augmented reality devices include a projection system. The projection system includes a projector including a major axis. The projected is configured to project an image along the major axis. A prism is configured to refract the image. The image includes a first spectrum, a second spectrum, and a third spectrum. A waveguide is disposed at a wrap angle from a plane formed from the major axis of the projector. The waveguide includes an input coupler, and an output coupler.

In another embodiment, the present disclosure generally provides augmented reality devices. The augmented reality devices include a projection system. The projection system includes a projector including a major axis. The projected is configured to project an image along the major axis. A doublet prism having a first prism and a second prism is configured to refract the image. The image includes a first spectrum, a second spectrum, and a third spectrum. A waveguide is disposed at a wrap angle from a plane formed from the major axis of the projector. The waveguide includes an input coupler, and an output coupler.

In another embodiment, the present disclosure generally provides augmented reality devices. The augmented reality devices include a projection system. The projection system includes a projector including a major axis. The projected is configured to project an image along the major axis. A prism having a refractive index of about 1.4 to about 1.5, and an Abbe-number of about 80 to about 90, is configured to refract the image. The image includes a first spectrum, a second spectrum, and a third spectrum. A waveguide is disposed at a wrap angle from a plane formed from the major axis of the projector. The waveguide includes an input coupler including a compensation angle including about 1 arcsec to about 5°, and an output coupler.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments of the present disclosure and are therefore not to be considered limiting of its scope, and may admit to other equally effective embodiments.

FIG. 1A is a schematic, top view of an augmented reality device, according to embodiments described herein.

FIG. 1B schematic cross-sectional view a portion of the augmented reality device in FIG. 1A, according to embodiments described herein.

FIG. 2A is schematic, cross-sectional view of a prism doublet, according to embodiments described herein.

FIG. 2B is schematic, cross-sectional view of a prism doublet, according to embodiments described herein.

FIG. 2C is schematic, cross-sectional view of a singlet prism, according to embodiments described herein.

FIG. 2D is schematic, cross-sectional view of a singlet prism, according to embodiments described herein.

FIG. 3A is graphical representation of an output angle distortion of a prism doublet, according to embodiments described herein.

FIG. 3B is graphical representation of a single color output angle dispersion of a prism doublet, according to embodiments described herein.

FIG. 4A is graphical representation of an output angle distortion of a singlet prism, according to embodiments described herein.

FIG. 4B is graphical representation of a single color output angle dispersion of a singlet prism, according to embodiments described herein.

FIG. 5A is graphical representation of an output angle distortion of a prism which is dispersion compensated by a grating, according to embodiments described herein.

FIG. 5B is graphical representation of a single color output angle dispersion of a prism which is dispersion compensated by a grating, according to embodiments described herein.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the present disclosure generally relate to waveguides for augmented, mixed, or virtual reality. Specifically, embodiments described herein provide for an optical system for use with augmented reality (AR) where a user can see through the display lenses of the glasses or other head-mounted display device to view the surrounding environment, and see images of virtual objects that are generated for display and appear as part of the environment. A prism, e.g., a single prism and/or a doublet prism, can be placed along the light path between the projector and the waveguide. Angling the projector at a projector tilt angle causes the optical system to lose ergonomics. Embodiments of the present disclosure relate to the combination of a prism and diffractive waveguide to minimize image blur, maintain ergonomics, and reduce manufacturing costs.

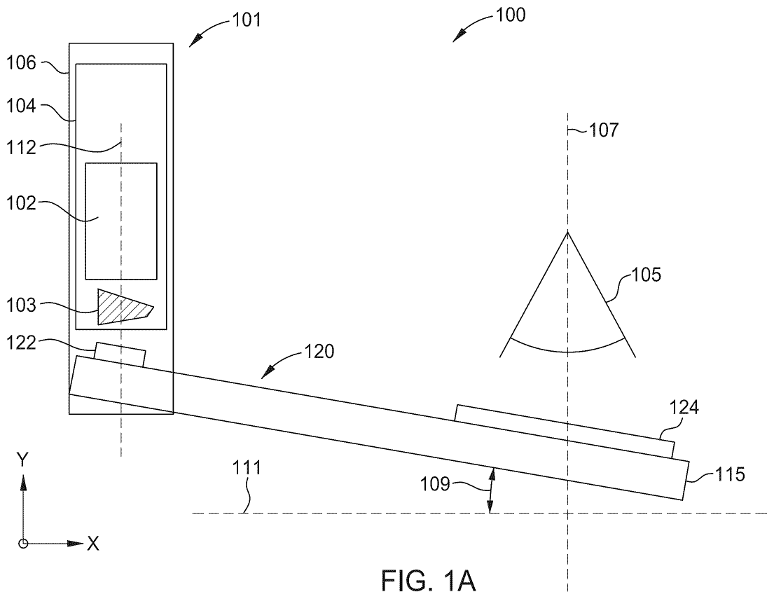

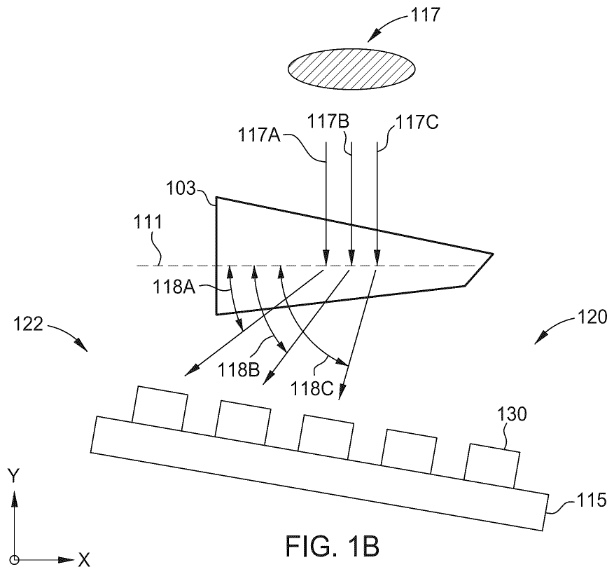

FIG. 1A is a schematic, top view of a device 100 for augmented reality. FIG. 1B is a schematic cross-sectional view a portion of the device 100 in operation. The device 100 includes a projection system 101 and a waveguide 120. The projection system 101 includes a projector 102 and a prism 103. The projector 102 is coupled to a frame arm 104. The frame arm 104 is coupled to a frame 106. The frame 106 retains the waveguide 120 and couples the waveguide 120 to the frame arm 104. The waveguide 120 is disposed at a wrap angle 109. A plane 111 is perpendicular to a major axis 112 of the projector 102. The plane 111 is formed having the major axis 112 as the normal vector to the plane 111. The device 100 includes a wrap angle 109 between the plane 111 and the waveguide 120. The wrap angle 109 is about −10° to about 30°. For example, the wrap angle 109 is about 1° to about 10°. In some embodiments, the major axis 112 of the projector 102 is about parallel to an eye axis 107 of the user's eye 105. In some embodiments, the major axis 112 of the projector 102 is angled about −10° to about 30° from the eye axis 107 of the user's eye 105.

It is desirable for the projector 102 to be aligned within the frame arm 104 while the waveguide 120 is disposed at the wrap angle 109 for improvements in ergonomics, reduced weight, and reduced device 100 size. The projector 102 and the prism 103 are disposed in the frame arm 104 such that the major axis 112 of the projector 102 is aligned with the frame arm 104. The prism 103 is configured to refract an image 117 from the projector 102 towards the waveguide 120. The prism 103 allows the projector 102 to be disposed in the frame arm 104 instead of angled inward toward a user's temple while still accounting for the wrap angle 109. This orientation allows for a reduction in width of the frame arm 104 of the frame 106, providing enhanced ergonomics. The projector 102 and prism 103 operating in conjunction with the waveguide 120 enables less complexity in the manufacturing of the prism 103 due to the waveguide 120 mitigating dispersion from the prism 103.

The projector 102 is operable to project the image 117 that include includes a first spectrum 117A, a second spectrum 117B, and a third spectrum 117C of light. In some embodiments, the first spectrum 117A, the second spectrum 117B, and the third spectrum 117C include the same wavelength of light. In some embodiments, the first spectrum 117A corresponds to a first wavelength of light, the second spectrum 117B corresponds to a second wavelength of light, and the third spectrum 117C corresponds to a third wavelength of light. The first wavelength of light, the second wavelength of light, and the third wavelength of light can independently be about 400 nm to about 700 nm, e.g., about 400 nm to about 600 nm, about 500 nm to about 700 nm, or about 450 nm to about 650 nm. The prism 103 of the projection system 101 enables the image 117 to be in-coupled by the waveguide 120. In operation, the first spectrum 117A, the second spectrum 117B, and the third spectrum 117C (hereinafter the “spectrums 117A, 117B, 117C”) are refracted by the prism 103 before entering an input coupler 122 of the waveguide 120 disposed at the wrap angle 109. The input coupler is disposed over a substrate 115.

The substrate 115 may include substrates of any suitable material, including, but not limited to, amorphous dielectrics, non-amorphous dielectrics, crystalline dielectrics, silicon-containing materials, polymers, and combinations thereof. In one embodiment, which can be combined with other embodiments described herein, the substrate 115 includes one or more of silicon (Si), silicon dioxide (SiO₂), silicon carbide (SiC), fused silica, diamond, or quartz materials. In some embodiment, which can be combined with other embodiments described herein, the substrate 115 includes of one or more of nitrogen, titanium, niobium, lanthanum, zirconium, or yttrium containing-materials. The substrate 115 may include optical material having a refractive index of about 2, e.g., about 1.7 to 2.3, about 1.8 to 2.2, about 1.9 to 2.1, or about 2.0 to 2.1.

The input coupler 122 can be on the same side of the substrate as the projector 102. The input coupler 122 can be on the opposite side of the substrate as the projector 102. The input coupler 122 including one or more input structures 130. The input structures have an input period and an input orientation. The input period is the distance between the midpoints of adjacent input structures. In some embodiments, the input period is defined as the distance between the leading edge of adjacent input structures. The input period is the same when measuring between the mid points or leading edge of adjacent input structures. The input period is about 150 nanometers (nm) to about 600 nm.

As seen in FIG. 1B, the first spectrum 117A, the second spectrum 117B, and the third spectrum 117C enter the input coupler 122 at a corresponding first input angle, second input angle, and third input angle (hereinafter the “input angles 118A 118B, 118C”). As the image 117 passes through the prism 103, different wavelengths of light bend and change speed as they travel between mediums with different refractive indexes. For example, when light travels from a lower refractive index to a higher refractive index, the light angles away from the normal vector. The wavelength of the light determines the degree at which the light angles away from the normal vector.

The prism 103 bends the image 117 from the projector 102 towards the input coupler 122 to account for the wrap angle 109. The prism 103 refracts the image 117 such that each of the spectrums 117A, 117B, 117C travel through the prism 103 at different rates and leave the prism 103 at different angles. The variations between the spectrums 117A, 117B, 117C cause the spectrums 117A, 117B, 117C to enter the input coupler at different input angles 118A 118B, 118C. In some embodiments, the prism 103 is a triangular prism. In some embodiments, the prism 103 is a trapezoidal prism. In some embodiments, the prism 103 is a doublet prism as described below, but other higher order prisms are contemplated.

The output coupler 124 includes output structures. The output structures have an output period and an output orientation. The output period is the distance between the midpoints of adjacent output structures. In some embodiments, the output period is defined as the distance between the leading edge of adjacent output structures. The output period is the same when measuring between the mid points or leading edges of adjacent output structures. The output period is about 150 nanometers (nm) to about 600 nm. The output orientation is defined as the angle between the x-axis and a normal vector of the output structures. The output orientation is greater or less than 90°.

Optionally, as the first spectrum 117A, the second spectrum 117B, and the third spectrum 117C enter the input coupler 122 at a corresponding first input angle, second input angle, and third input angle (the input angles 118A, 118B, 118C), the spectrums 117A, 117B, 117C undergo total internal reflection (TIR) within the waveguide 120. The projector 102 is configured to project the image 117 having the spectrums 117A, 117B, 117C dispersed by the prism 103 into the input coupler 122 at different input angles 118A, 118B, 118C. The first spectrum 117A, the second spectrum 117B, and the third spectrum 117C leave an output coupler 124 at substantially similar output angles, thereby producing an image having enhanced clarity and sharpness compared to a standard waveguide.

In a head-mounted display (HMD) that incorporates the device 100, disposing the waveguide 120 at the wrap angle 109 and aligning the major axis 112 of the projector 102 along the frame arm 104 improves usability of the device 100. Usability is improved by improving the comfort and reducing the size of a HMD while maintaining a clear image received by the user's eye 105. The device 100 incorporates the prism 103 to allow the projector 102 to be parallel with the frame arm 104. The waveguide 120 can compensate for any dispersion and refraction of the prism 103. The waveguide 120 can compensate for the prism 103 by diffracting the first spectrum 117A, the second spectrum 117B, and the third spectrum 117C such that the first spectrum 117A, the second spectrum 117B, and the third spectrum 117C travel to the user's eye 105 at the same angle from an output coupler 124.

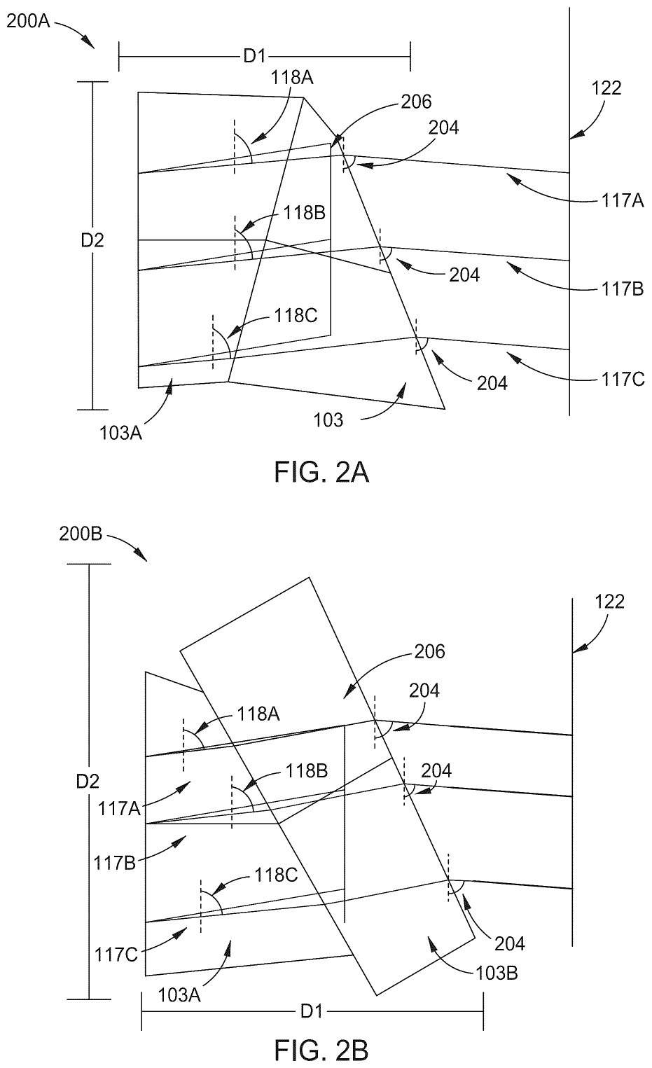

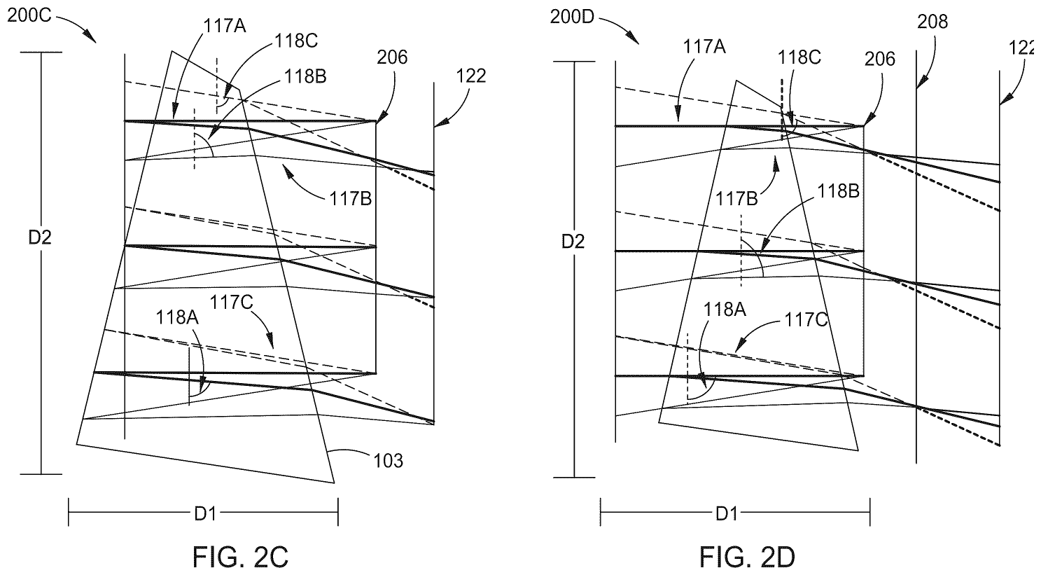

FIG. 2A is a schematic, cross-sectional view of a first prism doublet 200A. The first prism doublet 200A includes a first prism 103A and a second prism 103B. The first prism doublet 200A may include a width, D1, of about 1 millimeters (mm) to about 7 mm, e.g., about 5.1 mm to about 6.8 mm, about 5.2 mm to about 6.6 mm, or about 5.3 mm to about 6.4 mm. The first prism doublet 200A may include a height, D2, of about 1 mm to about 6 mm, e.g., about 5 mm to about 5.8 mm, about 5 mm to about 5.6 mm, or about 5.1 mm to about 5.2 mm. The first prism doublet 200A may include a depth (not shown) of about 1 mm to about 6 mm, e.g., about 5 mm to about 5.8 mm, about 5 mm to about 5.6 mm, or about 5.1 mm to about 5.2 mm.

The first prism 103A includes a prism configured to refract an image 117 from an input pupil beam 206 towards the second prism 103B. The first prism 103A may include a refractive index of about 1.5 to about 1.7, e.g., about 1.52 to about 1.69, about 1.53 to about 1.64, or about 1.58 to about 1.59. The first prism 103A may include an Abbe-number of about 65 to about 70, e.g., about 66 to about 70, about 67 to about 70, or about 68 to about 69. The first prism 103A may include a dense fluor crown material.

A first spectrum 117A, a second spectrum 117B, and a third spectrum 117C enter the first prism 103A at a corresponding first input angle, second input angle, and third input angle (hereinafter the “input angles 118A 118B, 118C”). As the image 117 passes through the first prism 103A, the wavelengths of light bend towards the second prism 103B. The amount the wavelengths of light bend may vary according to the wavelength of light of the image 117. For example, the wavelength of light may include a greater bend for a wavelength of about 480 nm, compared to a wavelength of about 600 nm.

The first prism 103A bends the image 117 towards the second prism 103B. The first prism 103A refracts the image 117 such that each of the spectrums 117A, 117B, 117C travel through the prism 103 at different rates and leave the first prism 103A at different angles. The variations between the spectrums 117A, 117B, 117C cause the spectrums 117A, 117B, 117C to enter the second prism 103B at different input angles 118A 118B, 118C. In some embodiments, the second prism 103B is a triangular chromatic prism. As shown in FIG. 2B, depicting a second prism doublet 200B, the second prism doublet 200B can include a second prism 103B having a chromatic prism. The second prism 103B can include a triangular prism. The second prism 103B can include a trapezoidal prism. The second prism 103B can include a dense lanthanum flint material.

The second prism 103B may include a refractive index of about 1.1 to about 2.2, e.g., about 1.1 to about 2.1, about 1.5 to about 2.05, or about 1.8 to about 2.1. The first prism 103A may include an Abbe-number of about 20 to about 25, e.g., about 21 to about 24, about 22 to about 24, or about 23 to about 24.

The second prism 103B includes a prism configured to refract an image 117 towards the input coupler 122. For example, a first spectrum 117A, a second spectrum 117B, and a third spectrum 117C enter the second prism 103B at a corresponding first input angle, second input angle, and third input angle (hereinafter the “input angles 118A 118B, 118C”), in which as the image 117 passes through the second prism 103B, the wavelengths of light bend towards the input coupler 122 at a corresponding second input angle 204. The second prism 103B refracts the image 117 such that each of the spectrums 117A, 117B, 117C travel through the second prism 103B at equal rates and leave the second prism 103B at equal angles. Without being bound by theory, a second prism can tilt the output beam of the device due to the equal exit angle of the image 117, thereby reducing dispersion and enhancing image clarity.

FIG. 2C is a schematic, cross-sectional view of a first prism singlet 200C. The first prism singlet 200C includes a first prism 103A. The first prism 103A includes a prism configured to refract an image 117 towards the input coupler 122. The first prism 103A may include a width, D1, of about 1 mm to about 7 mm, e.g., about 3.1 mm to about 4.8 mm, about 3.2 mm to about 3.6 mm, or about 3.3 mm to about 3.4 mm. The first prism 103A may include a height, D2, of about 1 mm to about 6 mm, e.g., about 5 mm to about 5.8 mm, about 5 mm to about 5.6 mm, or about 5.1 mm to about 5.2 mm. The first prism singlet 200C may include a depth (not shown) of about 1 mm to about 6 mm, e.g., about 5 mm to about 5.8 mm, about 5 mm to about 5.6 mm, or about 5.1 mm to about 5.2 mm.

The first prism 103A may include a refractive index of about 1.4 to about 1.7, e.g., about 1.42 to about 1.49, about 1.43 to about 1.49, or about 1.48 to about 1.49. The first prism 103A may include an Abbe-number of about 65 to about 90, e.g., about 82 to about 88, about 83 to about 87, or about 84 to about 85. The first prism 103A may include a fluorine crown material.

A first spectrum 117A, a second spectrum 117B, and a third spectrum 117C enter the first prism 103A at a corresponding first input angle, second input angle, and third input angle (hereinafter the “input angles 118A 118B, 118C”). As the image 117 passes through the first prism 103A, the wavelengths of light bend towards the input coupler 202. The amount the wavelengths of light bend may vary according to the image 117.

The first prism 103A bends the image 117 towards the input coupler 122. The first prism 103A refracts the image 117 such that each of the spectrums 117A, 117B, 117C travel through the prism 103 at different rates and leave the first prism 103A at different angles. The variations between the spectrums 117A, 117B, 117C cause the spectrums 117A, 117B, 117C to enter the input coupler 122 at different input angles 118A 118B, 118C. In some embodiments, the first prism 103A is a trapezoidal chromatic prism of a fluorine crown material.

FIG. 2D is a schematic, cross-sectional view of a second prism singlet 200D. The second prism singlet 200D includes a corrective input coupler 208. The corrective input coupler 208 includes a corrective grating. The corrective grating can compensate for any dispersion and refraction of the first prism 103A such that the corrective input coupler 208. The can compensate for the first prism 103A by diffracting the first spectrum 117A, the second spectrum 117B, and the third spectrum 117C along a similar angle. For example, the corrective input coupler 208 can refracts the image 117 in the waveguide 120 such that each of the spectrums 117A, 117B, 117C travel through the waveguide 120 at equal rates and leave the output coupler 124 at equal angles. Without being bound by theory, by leaving the output coupler 124 at equal angles, the first spectrum 117A, the second spectrum 117B, and the third spectrum 117C travel to the user's eye 105 at the same angle from the output coupler 124, thereby enhancing clarity and sharpness of the image 117.

The corrective input coupler 208 can diffract the spectrums 117A, 117B, 117C to compensate for the refractive dispersion from the prism 103. The corrective input coupler 208 can include a compensation angle. The compensation angle is an angle between a normal vector of the input structures of the corrective input coupler 208 and a normal vector of the input structures of the input coupler 122. The compensation angle is about 1 arcsec to about 5°. Without being bound by theory, the compensation angle of about 1 arcsec to about 5° can compensate for the different input angles 118A, 118B, 118C to produce an image at an about uniform angle that is sharp when viewed by the user's eye 105.

### EXAMPLES

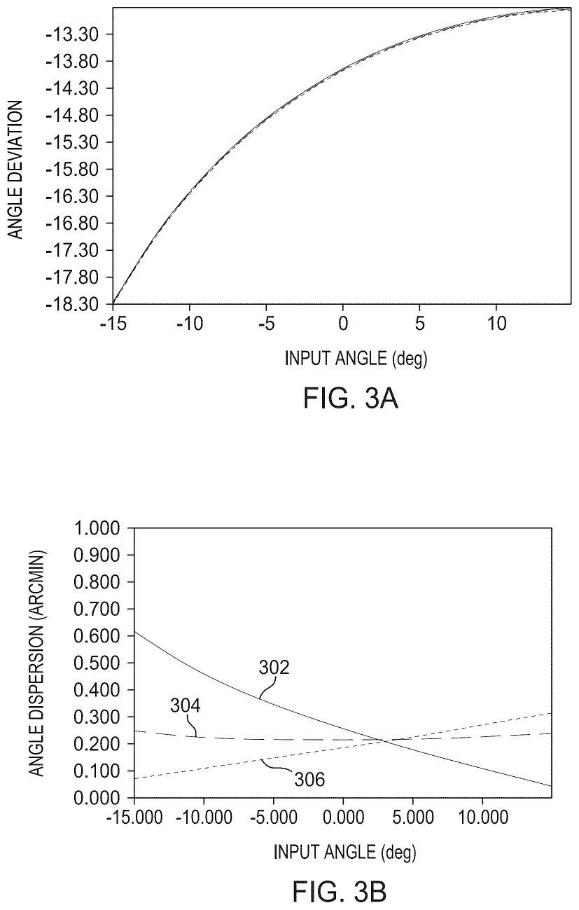

Now referring to FIG. 3A, a graphical representation of an output angle distortion of a prism doublet is shown. The prism doublet included a width of about 1 mm to about 7 mm, a height of about 5 mm to about 6 mm, and a depth of about 4 mm to about 5 mm. The prism doublet included a first prism material of FCD505, having a refractive index of 1.5928, and an Abbe number of 68.624. The prism doublet included a second prism material of TAFD43, having a refractive index of 2.0029, and an Abbe number of 23.513.The output angle distortion had an angle deviation of about −18.30 at −15 degrees and an angle deviation of about −12.8 at an angle deviation of 15 degrees. A single color output angle dispersion was determined for a single color, e.g., a first color 302, a second color 304, and a third color 306. The first color 302 included a blue wavelength of light, the second color 304 included a red wavelength of light, and the third color 306 included a green wavelength of light.

At an input angle of −15 degrees to 15 degrees, each of the first color 302, the second color 304, and the third color 306 had an angle dispersion of less than 0.7 arcmin, as shown in FIG. 3B. For example, the first color 302 had an angle dispersion of less than 0.7 arcmin, the second color 304 had an angle dispersion of less than 0.3 arcmin, and the third color 306 had an angle dispersion of less than 0.35 arcmin. Without being bound by theory, an angle dispersion of less than 1 arcmin enhances the optical clarity of the image perceived by an individual.

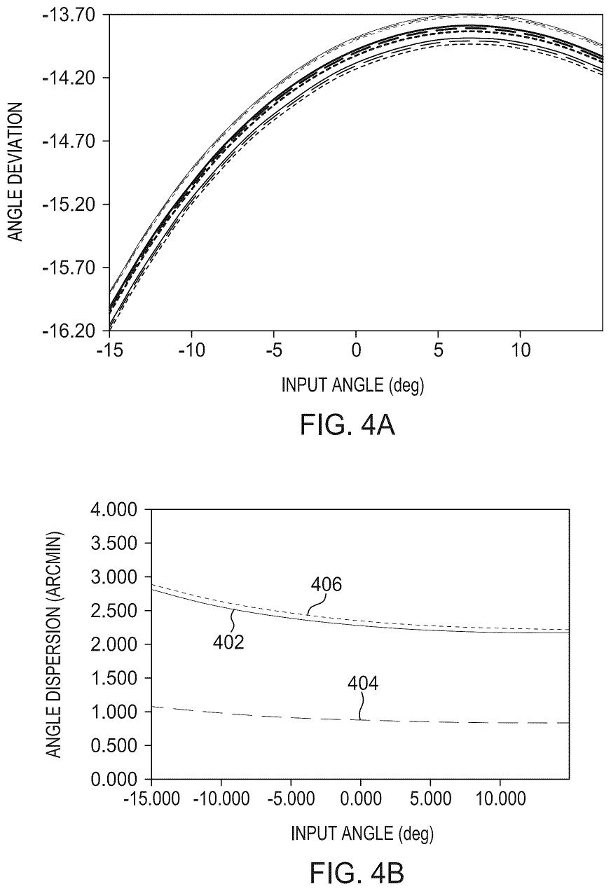

Now referring to FIG. 4A, a graphical representation of an output angle distortion of a prism singlet is shown. The prism singlet included a width of about 3 mm to about 4 mm, a height of about 5 mm to about 6 mm, and a depth of about 4 mm to about 5 mm. The prism singlet included a prism material of fluorine crown material, having a refractive index of 1.4866 at 589.3 nm, and an Abbe number of 84.468. The output angle distortion had an angle deviation of about −16 at an input angle of −15 degrees and an input angle of about −13 at an angle deviation of 15 degrees.

A single color output angle dispersion was determined for a single color, e.g., a first color 402, a second color 404, and a third color 406. The first color 402 included a blue wavelength of light, the second color 404 included a red wavelength of light, and the third color 406 included a green wavelength of light, as shown in FIG. 4B. The first color 402 had an angle dispersion of about 2 arcmin to about 3 arcmin, the second color 404 had an angle dispersion of about 0.8 arcmin to about 1.2 arcmin, and the third color 406 had an angle dispersion of about 2 arcmin to about 3 arcmin.

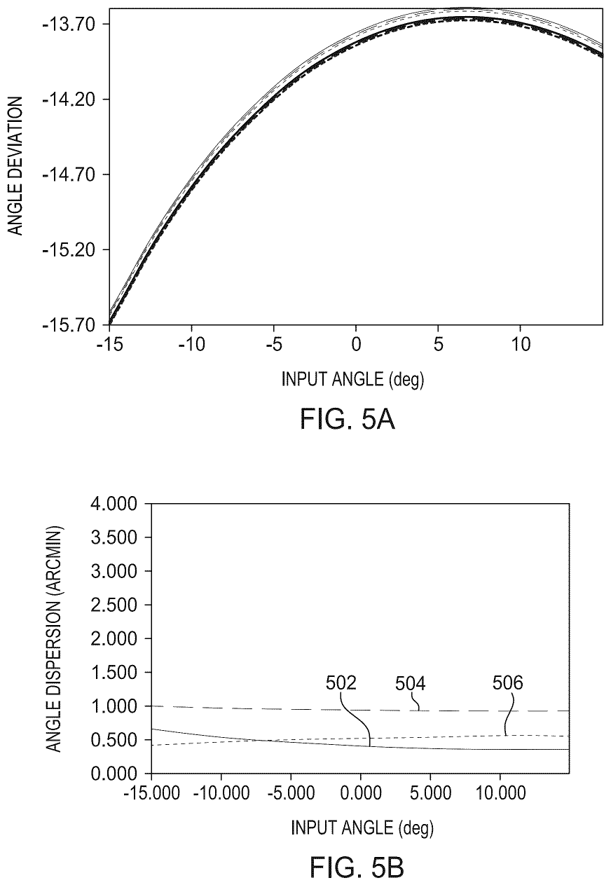

Now referring to FIG. 5A, a graphical representation of an output angle distortion of a prism singlet coupled to a corrective input coupler is shown. The prism singlet included a width of about 3 mm to about 4 mm, a height of about 5 mm to about 6 mm, and a depth of about 4 mm to about 5 mm. The prism singlet included a prism material of FK51, having a refractive index of 1.4866 at 589.3 nm, and an Abbe number of 84.468. The corrective input coupler included an input period of about 40 μm and a an input vector of 0.025 (1/μm).

The output angle distortion had an angle deviation of about −15 at an input angle of −15 degrees and an angle deviation of about −13 at an input angle of 15 degrees. A single color output angle dispersion was determined for a single color, e.g., a first color 402, a second color 404, and a third color 406. The first color 402 included a blue wavelength of light, the second color 404 included a red wavelength of light, and the third color 406 included a green wavelength of light, as shown in FIG. 5B. At an input angle of −15 degrees to 15 degrees, each of the first color 502, the second color 504, and the third color 506 had an angle dispersion of less than 1.0 arcmin. The first color 502 had an angle dispersion of about 0.3 arcmin to about 0.75 arcmin, the second color 504 had an angle dispersion of about 0.8 arcmin to about 1 arcmin, and the third color 506 had an angle dispersion of about 0.3 arcmin to about 0.6 arcmin. Without being bound by theory, the corrective input coupler coupled to the prism singlet reduced the angle dispersion to below 1 arcmin, thereby enhancing the optical clarity of the image perceived by the individual.

Overall, the device 100 described herein includes improved usability by improving the comfort and reducing the size of a HMD while maintaining image clarity seen by a user's eye. The device 100 incorporates the prism 103, e.g., a single prism and/or a doublet prism, to allow the projector 102 to be aligned within the frame arm 104. A combination of the prism 103, e.g., a single prism and/or a doublet prism, and waveguide 120 further enables weight savings due to the reduction of complex prisms. A waveguide 120 compensates for any dispersion and refraction caused by a single prism, allowing the image to enter the waveguide 120 as different spectrums at different input angles, but the different spectrums leave the waveguide 120 at about the same output angle. By compensating for dispersion with the waveguide 120, costs of expensive complex prisms can be reduced.

While the foregoing is directed to embodiments of the disclosure, other and further embodiments may be devised without departing from the basic scope thereof, and the scope thereof is determined by the claims that follow.

What is claimed is:

1. An augmented reality device comprising:
a projection system comprising:
a projector comprising a major axis, the projector configured to project an image along the major axis; and
a prism configured to refract the image, the image comprising a first spectrum, a second spectrum, and a third spectrum; and
a waveguide disposed at a wrap angle from a plane formed from the major axis of the projector, the waveguide comprising:
an input coupler; and
an output coupler.

2. The augmented reality device of claim 1, wherein the prism comprises a dense fluor crown material, a dense lanthanum flint material, or a fluorine crown material.

3. The augmented reality device of claim 1, wherein the prism comprises a prism doublet, wherein the prism doublet comprises a first prism and a second prism.

4. The augmented reality device of claim 3, wherein the first prism comprises a refractive index of about a first refractive index of about 1.4 to about 1.7, and the second prism comprises a second refractive index of about 1.8 to about 2.2.

5. The augmented reality device of claim 3, wherein the first prism comprises a first Abbe-number of about 65 to about 90, and the second prism comprises a second Abbe-number of about 20 to about 25.

6. The augmented reality device of claim 1, wherein the prism comprises:
a width of about 1 millimeter (mm) to about 7 mm; and
a height of about 1 mm to about 6 mm.

7. The augmented reality device of claim 1, wherein the input coupler is disposed along the major axis.

8. The augmented reality device of claim 7, wherein the prism is disposed along the major axis and between the projector and the waveguide.

9. The augmented reality device of claim 1, wherein the input coupler comprises a compensation angle comprising about 1 arcsec to about 5°.

10. An augmented reality device comprising:
a projection system comprising:
a projector comprising a major axis, the projector configured to project an image along the major axis; and
a doublet prism having a first prism and a second prism, wherein the doublet prism is configured to refract the image, the image comprising a first spectrum, a second spectrum, and a third spectrum; and
a waveguide disposed at a wrap angle from a plane formed from the major axis of the projector, the waveguide comprising:
an input coupler; and
an output coupler.

11. The augmented reality device of claim 10, wherein the first prism comprises a dense fluor crown material, and the second prism comprises a dense lanthanum flint material.

12. The augmented reality device of claim 10, wherein the first prism comprises a refractive index of about a first refractive index of about 1.4 to about 1.7, and the second prism comprises a second refractive index of about 1.8 to about 2.2.

13. The augmented reality device of claim 10, wherein the first prism comprises a first Abbe-number of about 65 to about 90, and the second prism comprises a second Abbe-number of about 20 to about 25.

14. The augmented reality device of claim 10, wherein the doublet prism comprises:
a width of about 1 mm to about 7 mm; and
a height of about 1 mm to about 6 mm.

15. An augmented reality device comprising:
a projection system comprising:
a projector comprising a major axis, the projector configured to project an image along the major axis; and
a prism comprising a refractive index of about 1.4 to about 1.5, and an Abbe-number of about 80 to about 90, configured to refract the image, the image comprising a first spectrum, a second spectrum, and a third spectrum; and
a waveguide disposed at a wrap angle from a plane formed from the major axis of the projector, the waveguide comprising:
an input coupler comprising a compensation angle comprising about 1 arcsec to about 5°; and
an output coupler.

16. The augmented reality device of claim 15, wherein the prism comprises a fluorine crown material.

17. The augmented reality device of claim 15, wherein the prism comprises a width of about 1 mm to about 7 mm.

18. The augmented reality device of claim 15, wherein the prism comprises a height of about 1 mm to about 6 mm.

19. The augmented reality device of claim 15, wherein the input coupler is disposed along the major axis.

20. The augmented reality device of claim 19, wherein the prism is disposed along the major axis and between the projector and the waveguide.
